(19) United States
(12) Patent Application Publication
(10) Pub. No.: US 2015/0068618 A1
(43) Pub. Date: Mar. 12, 2015

(54) VALVE ASSEMBLY

(71) Applicant: Caterpillar Inc., Peoria, IL (US)

(72) Inventor: Herbert H. Speas, Oreana, IL (US)

(73) Assignee: Caterpillar Inc., Peoria, IL (US)

(21) Appl. No.: 14/020,962

(22) Filed: Sep. 9, 2013

(51) Int. Cl. F16K 31/22; F01N 3/20

(52) U.S. Cl. CPC F16K 31/22; F01N 3/208; F01N 2610/1413
USPC 137/433

(57) ABSTRACT

A valve is provided. A body of the valve is configured to receive a supply of fluid. The body includes an inlet. A chamber is defined within the body. A seat member is disposed within the chamber. The seat member includes apertures defining a fluid flow path from the inlet into the chamber. A plunger is disposed through the body and in fluid communication with the chamber. The plunger includes a tubular wall defining a conduit therethrough. A float is attached to a distal end of the plunger. The plunger and the float are configured to move relative to the body and the seat member between an open position and a closed position. The apertures in the seat member are positioned radially outward of the tubular wall of the plunger.

### TECHNICAL FIELD

The present disclosure relates to a valve, and more specifically to the valve present on a fluid reservoir or tank.

### BACKGROUND

A diesel exhaust fluid (DEF) tank associated with an aftertreatment system of an engine may be filled using a pressurized fill system. However, when DEF present within the tank solidifies, an expansion in a volume of the DEF may cause the tank to get damaged. In some situations, this may lead to rupture of the tank.

U.S. Published Application Number 2012/0186677 relates to an exhaust after-treatment system associated with a diesel engine including a diesel exhaust fluid storage unit. The storage unit includes a diesel exhaust fluid tank and a vent system coupled to the tank and configured to regulate flow of air into the tank and fluid vapour out of the tank.

### SUMMARY OF THE DISCLOSURE

In one aspect of the present disclosure, a valve is provided. A body of the valve is configured to receive a supply of fluid. The body includes an inlet. A chamber is defined within the body. A seat member is disposed within the chamber. The seat member includes apertures defining a fluid flow path from the inlet into the chamber. A plunger is disposed through the body and in fluid communication with the chamber. The plunger includes a tubular wall defining a conduit therethrough. A float is attached to a distal end of the plunger. The plunger and the float are configured to move relative to the body and the seat member between an open position and a closed position. The apertures in the seat member are positioned radially outward of the tubular wall of the plunger.

In another aspect, a diesel exhaust fluid (DEF) tank is provided. A valve is positioned at a top surface of the tank. The valve has an inlet configured to receive a supply of DEF. The valve includes a body defining a chamber within the body. A seat member is disposed within the chamber. The seat member includes apertures defining a DEF flow path from the inlet into the chamber. A plunger is disposed through the body and in fluid communication with the chamber. The plunger includes a tubular wall defining a conduit therethrough. A float is attached to a distal end of the plunger. The plunger and the float are configured to move relative to the body and the seat member between an open position and a closed position. The apertures in the seat member are positioned radially outward of the plunger tubular wall.

In yet another aspect, a valve assembly is provided. The valve assembly includes a body configured to receive a supply of fluid. The body defines a chamber within the body. The body comprises an inlet. A seat member is disposed within the chamber. The seat member includes apertures defining a fluid flow path from the inlet into the chamber. A plunger is disposed through the lower portion and in fluid communication with the chamber. The plunger includes a tubular wall defining a conduit therethrough. A float is attached to a distal end of the plunger. The plunger and the float are configured to move relative to the body and the seat member between an open position and a closed position. The apertures in the seat member are positioned radially outward of the plunger tubular wall.

Other features and aspects of this disclosure will be apparent from the following description and the accompanying drawings.

### BRIEF DESCRIPTION OF THE DRAWINGS

FIG. 1 is a perspective view of an exemplary diesel exhaust fluid (DEF) tank, according to one embodiment of the present disclosure;

FIG. 2 is a cross sectional view of the tank of FIG. 1 having a valve in an open position attached to the tank;

FIG. 3 is a cross sectional view of the valve of FIG. 2, the valve being in a closed position; and

FIG. 4 is a cross sectional view of another configuration of the valve, according to another embodiment of the present disclosure.

### DETAILED DESCRIPTION

Wherever possible, the same reference numbers will be used throughout the drawings to refer to the same or the like parts. The present disclosure relates to a reductant delivery and supply system 100 associated with an aftertreatment module of an engine (not shown). The aftertreatment module may be used to treat an exhaust stream which leaves the engine. The exhaust stream generally contains emissions which may include nitrogen oxides (NOx), unburned hydrocarbons, and particulate matter. The aftertreatment module is generally designed to reduce the content of NOx, unburned hydrocarbons, particulate matter, or other components of the emissions prior to the exhaust stream being released from the engine.

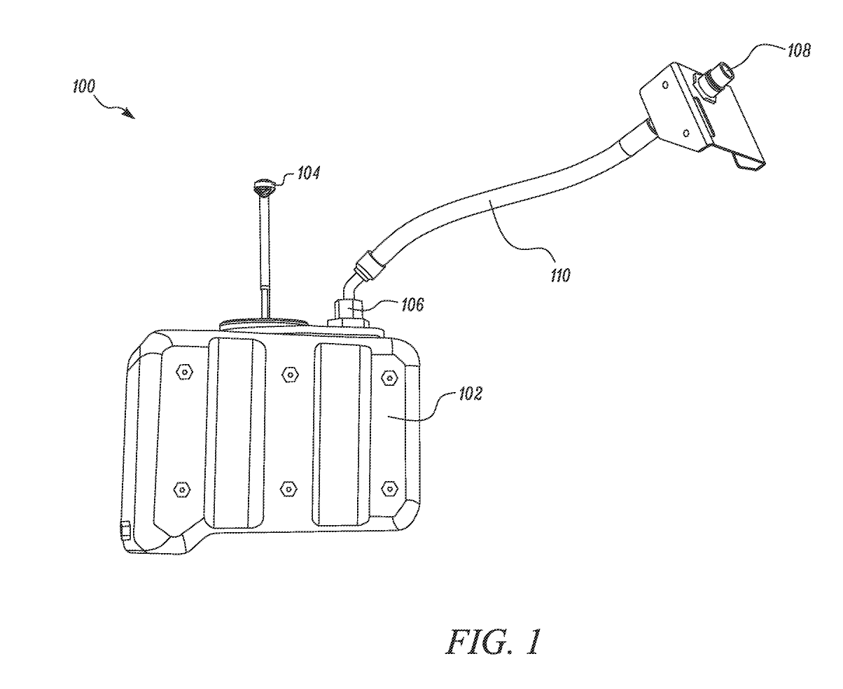

The reductant delivery and supply system 100 may include a storage tank or a Diesel Exhaust Fluid (DEF) tank, a dosing module (not shown) and other components for supplying a reductant, such as DEF, to the aftertreatment module. Alternative liquid reductants may comprise ammonia or any other reducing agent. FIG. 1 illustrates a perspective view of an exemplary DEF tank 102, hereinafter referred to as the tank 102, according to one embodiment of the present disclosure. The tank 102 may be positioned inside a machine (not shown). The tank 102 may be fluidly connected to the dosing module via a port 104 for supplying the DEF into the exhaust stream of the engine. The tank 102 may be made of a polymer, a metal or any other known material. Parameters related to the tank 102, such as, shape, dimensions, material used and location of the tank 102 may vary as per the system requirements.

A receiving element 106 may be attached to the tank 102 for receiving the DEF into the tank 102 from an external source (not shown) of DEF supply. In one embodiment, the receiving element 106 may be positioned on a top surface of the tank 102. The receiving element 106 may be fluidly connected to a receptacle 108 positioned on a frame (not shown) of the machine. A hose 110, a flexible pipe or any other filling line defining a conduit therein for a flow of the DEF into the receiving element 106 may be utilized to form the connection between the receiving element 106 and the receptacle 108. The receptacle 108 is configured to receive a source of DEF supply therein, in order to provide the flow of DEF into the tank 102. In one embodiment, the source of DEF supply may include a nozzle (not shown) from the external source. A person of ordinary skill in the art will appreciate that any other known method to fill the tank 102 may also be utilized without any limitation.

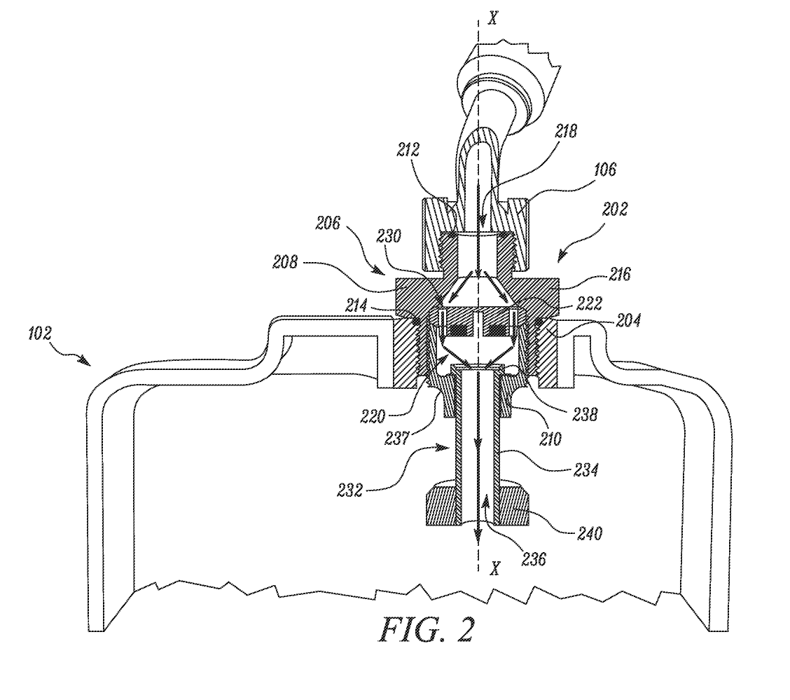

FIG. 2 illustrates a cross sectional view of the tank 102. A valve 202 is coupled to a receiving element 106 such that the valve 202 fluidly connects the receiving element 106 and the tank 102. In one embodiment, the valve 202 may be positioned within a receiver port 204 positioned on the top surface of the tank 102. As illustrated, the valve 202 may be connected to the receiving element 106 and extend into the tank 102 through the receiver port 204. The receiver port 204 may be welded, brazed or soldered to the tank 102. Alternatively the receiver port 204 may be threadedly coupled to the tank 102, as shown in the exemplary embodiment. The type of connection between the receiver port 204 and the tank 102 may be based on the material used to form the receiver port 204 and the tank 102 respectively. For example, when the tank 102 is made of metal, the receiver port 204 may be welded to the top surface of the tank 102.

The valve 202 may include a body 206 having an upper portion 208 and a lower portion 210 defining a longitudinal axis X-X of the valve 202. As shown in the accompanying figures, the upper portion 208 of the valve 202 may be coupled to the receiving element 106. For example, the upper portion 208 of the valve 202 may be threadedly coupled to the receiving element 106. As illustrated, threads provided on an inner surface of the receiving element 106 may be configured to mate with corresponding threads provided on an outer surface of one end of the upper portion 208 of the valve 202. In one embodiment, a sealing ring 212 may be provided between the receiving element 106 and the upper portion 208 of the body 206 for preventing leakage of the DEF therebetween.

Also, the upper portion 208 of the body 206 may be coupled to the receiver port 204 for holding the valve 202 in position on the top surface of the tank 102. Another end of the upper portion 208 of the valve 202 may be received into and coupled to the receiver port 204 using any known method in the art. As shown, the upper portion 208 of the valve 202 may be threadedly coupled to the receiver port 204. In one embodiment, a sealing ring 214 may be provided between the outer surface of the upper portion 208 of the valve 202 and the tank 102 for sealing the valve 202 with respect to the tank 102.

The upper portion 208 may include a collar 216 configured to be located adjacent to a top surface of the receiver port 204 and rest thereon when the valve 202 is assembled into the tank 102. Further, the upper portion 208 of the body 206 may define an inlet 218 therein. The inlet 218 may be positioned along the longitudinal axis X-X. The inlet 218 of the body 206 may be configured to receive the DEF flow from the receiving element 106 when the tank 102 is being filled. The upper portion 208 of the body 206 may be coupled to the lower portion 210 of the body 206. For example, the upper portion 208 of the body 206 may be threadedly coupled to the lower portion 210. Alternatively, the upper and lower portions 208, 210 may be coupled using any other known means, or be portions of an integrally formed body 206. Accordingly, the lower portion 210 of the body 206 may be partially positioned within the upper portion 208 of the body 206, and may further extend into the tank 102.

The lower portion 210 of the body 206 may have a hollow configuration such that a chamber 220 is defined within the lower portion 210 of the body 206. In one embodiment, the lower portion 210 of the body 206 may have a substantially cylindrical configuration. A person of ordinary skill in the art will appreciate that the shape and dimensions of the upper and lower portions 208, 210 of the body 206 may vary based on the application. Also, the upper and lower portions 208, 210 of the body 206 may be made from a metal, a plastic, a composite, or any other suitable material.

A seat member 222 is disposed within the body 206 of the valve 202. More particularly, the seat member 222 is positioned within the chamber 220 of the body 206. For example, the seat member 222 may be positioned at a location at which the upper and lower portions 208, 210 of the body 206 are coupled. In another example, the seat member 222 may be positioned within the lower portion 210 of the body 206. The seat member 222 may be made of rubber, metal, plastic, or any other suitable material. In one embodiment, the seat member 222 may be fitted into the chamber 220 and held in position within a step, a groove, a chamfer or any other locking means provided within the body 206 of the valve 202. In one embodiment, the seat member 222 may have a substantially circular configuration such that the seat member 222 may form a good fit within the body 206 of the valve 202.

A number of apertures 230 are provided through the seat member 222. These apertures 230 may define a fluid flow path for the DEF from the inlet 218 of the body 206 into the chamber 220 of the lower portion 210 of the body 206. The apertures 230 may be provided in a circumferentially spaced apart arrangement near a periphery of the seat member 222. In one embodiment, the apertures 230 may have a kidney-shaped design. Alternatively, the apertures 230 may have a circular shape or any other configuration.

Further, a plunger 232 is disposed within the body 206 of the valve 202. More particularly, the plunger 232 may be disposed within the lower portion 210 of the body 206 and may extend into the tank 102. The plunger 232 may have a tubular wall 234 defining a conduit 236 within the plunger 232 for fluidly connecting the chamber 220 of the valve 202 with the tank 102. The plunger 232 may be positioned at a distal end of the body 206 with respect to the receiving element 106, and may selectively allow the DEF to flow from the chamber 220 of the valve 202 into the tank 102 based on a position of the valve 202.

As shown in the accompanying figures, the chamber 220 is sized to be larger than the plunger 232 such that the chamber 220 defined within the body 206 of the valve 202 surrounds a portion of the plunger 232 which is disposed within the body 206. In one embodiment, an external fillet 237 may extend from the lower portion 210 of the body 206 into the tank 102. The external fillet 237 may taper from the lower portion 210 of the body 206 and is shaped to surround a portion of the plunger 232 enclosed therein. The external fillet 237 may guide movement of the plunger 232 with respect to the chamber 220 of the body 206. Sizing of the external fillet 237 may be such that DEF is prevented from leaking between the lower portion 210 of the body 206 and the plunger 232.

One end of the plunger 232 which is received into the chamber 220 of the valve 202 may include a lip 238 extending circumferentially from the tubular wall 234. This may serve as a stop for holding the plunger 232 within the chamber 220 of the body 206 when the valve 202 is in an open position. A float 240 may be fixed to a distal end of the plunger 232. The float 240 is configured to be positioned within the tank 102 and may surround the distal end of the plunger 232. Also, the plunger 232 may be configured to pass through the float 240, such that a fluid flow path is defined through the conduit 236 of the plunger 232 into the tank 102.

The operation of the valve 202 will now be described in detail. Referring to FIG. 2, the valve 202 is shown in the open position. The DEF may be supplied to the receiving element 106 from the receptacle 108 via the hose 110. Further, the DEF may flow into the inlet 218 of the body 206 of the valve 202. The DEF may then enter into the chamber 220 of the body 206 by passing through the apertures 230 defined within the seat member 222. The DEF may flow through the chamber 220 into the conduit 236 of the plunger 232 and thereby enter into the tank 102. Arrows shown in FIG. 2 are indicative of a direction of the flow of DEF.

As a level of the DEF within the tank 102 increases, the DEF inside the tank 102 may come in contact with the float 240 disposed within the tank 102. A buoyancy force of the DEF may cause the plunger 232 and the float 240 to move relative to the body 206 and the seat member 222 of the valve 202. More particularly, the plunger 232 and the float 240 may move in a vertically upward direction into the chamber 220 of the body 206. In one embodiment, the movement of the plunger 232 within the chamber 220 may be guided by the part of the lower portion 210 of the body 206 between the open position and a closed position.

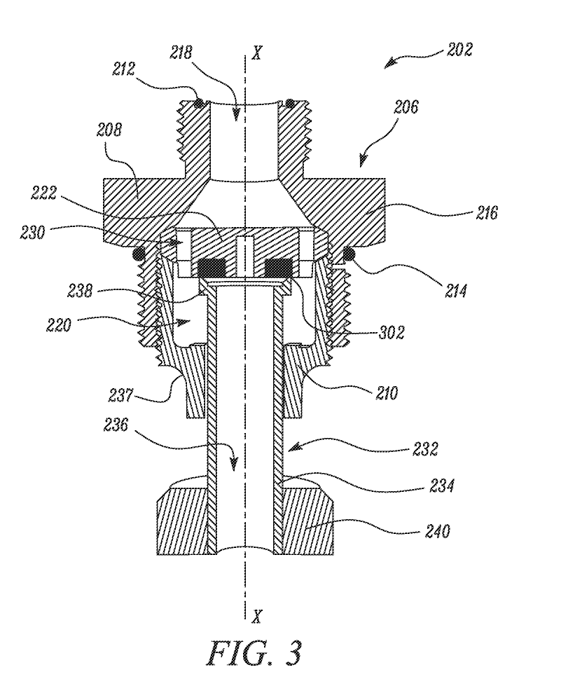

FIG. 3 is a cross sectional view of the valve 202 in the closed position, according to one embodiment of the present disclosure. When in the closed position, the plunger 232 may come in contact and seal against a lower section of the seat member 222. In one embodiment, a sealing surface 302, such as, for example, a gasket, may be located on the lower section of the seat member 222. This sealing surface 302 may be positioned so as to cooperate with the lip 238 of the plunger 232 when the valve 202 is in the closed position. The sealing surface 302 may be attached to the seat member 222 by any known means.

Moreover, a position of the plunger 232 with respect to the seat member 222 is such that the conduit 236 defined by the plunger 232 is isolated or fluidly disconnected from the chamber 220 of the valve 202 in the closed position. When the valve 202 is in the closed position, as the DEF is received through the inlet 218 of the valve 202, the DEF may flow through the apertures 230 and accumulate within the chamber 220 of the valve 202 surrounding the portion of the plunger 232 received into the body 206. It should be noted that the apertures 230 provided within the seat member 222 are positioned in a manner such that the apertures 230 lie radially outward of the tubular wall 234 of the portion of the plunger 232 disposed within the body 206. The DEF accumulated within the chamber 220 of the valve 202 may be prevented from entering into the tank 102 based on the sealing of the plunger 232 against the seat member 222. The DEF accumulated within the chamber 220 of the valve 202 may exert a radial pressure perpendicular to the longitudinal axis X-X and therefore does not exert a downward force on the plunger 232, which would tend to open the valve 202 by moving the plunger 232 into the tank 102.

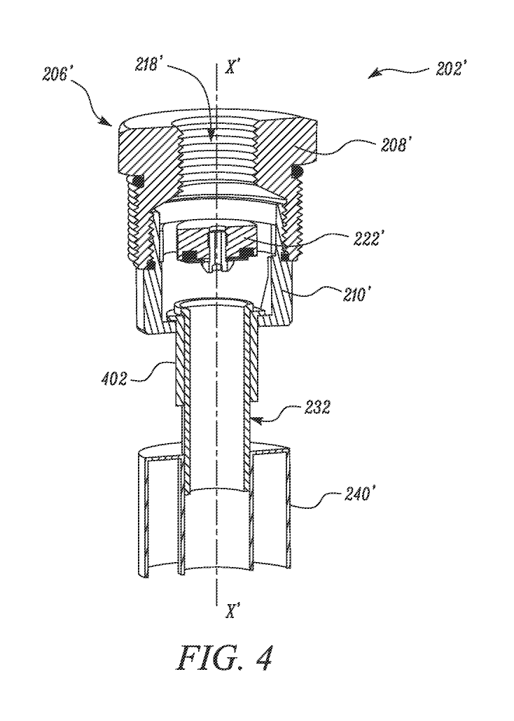

FIG. 4 illustrates a cross section view of another embodiment of the valve 202′, according to the present disclosure. In this embodiment, the upper portion 208′ of the body 206′ is shaped differently from that shown in FIGS. 2 and 3. The receiving element (not shown) is inserted into and coupled within the inlet 218′ of the body 206′. Further, the seat member 222′ is positioned within the lower portion 210′ of the body 206′. Also, a guiding member 402 is fixedly attached to a lower surface of the lower portion 210′ of the body 206′. The guiding member 402 has a hollow configuration and is sized to surround a portion of the plunger 232 extending into the tank 102. The guiding member 402 is configured to guide the movement of the plunger 232 and the float 240′ with respect to the body 206′ and the seat member 222′ of the valve 202′. The float 240′ may include a circumferential channel surrounding the distal end of the plunger 232 for receiving the DEF therein. The working of the valve 202′ is as described in connection with FIGS. 2 and 3.

It should be noted that the components of the valve 202, 202′ such as the upper portion 208, 208′, the lower portion 210, 210′, the seat member 222, 222′, the plunger 232 and the float 240, 240′ may be unitary components, an integrated component or any combination thereof based on the system requirements.

### INDUSTRIAL APPLICABILITY

Expansion of the DEF within the tank on solidification may cause rupturing of the tank design known in the art. The valve 202, 202′ disclosed herein may provide a simple and cost effective solution for shutting-off the DEF supply to the tank 102 when the DEF level within the tank 102 exceeds a predetermined threshold. Accordingly, space may be provided within the tank 102 to allow the DEF to expand without causing damage to the tank 102. Also, a mounting location of the valve 202, 202′ with respect to the tank 102 is such that the body 206 of the valve 202, 202′ is not in contact with the DEF present within the tank 102, thereby avoiding freezing damage concerns and additional leak paths that may arise with respect to the tank 102. The valve 202, 202′ is attachable from outside of the tank 102 allowing for ease of assembly and removal. The valve 202, 202′ may be utilized in connection with any storage unit which is filled by known pressurized fill systems for controlling a level of fluid filled in the storage unit.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A valve comprising:
a body configured to receive a supply of fluid, the body including an inlet and defining a chamber within the body;
a seat member disposed within the chamber, the seat member including apertures defining a fluid flow path from the inlet into the chamber;
a plunger disposed through the body and in fluid communication with the chamber, the plunger including a tubular wall defining a conduit therethrough; and
a float attached to a distal end of the plunger, wherein the plunger and the float are configured to move relative to the body and the seat member between an open position and a closed position, and wherein the apertures in the seat member are positioned radially outward of the plunger tubular wall.

2. The valve of claim 1 further comprising a sealing surface located on the seat member configured to cooperate with the plunger in the closed position.

3. The valve of claim 1, wherein the chamber is sized to be larger than the plunger such that the chamber defined within the body surrounds a portion of the plunger disposed within the body.

4. The valve of claim 1, wherein the body comprises an upper portion and a lower portion, wherein the upper portion and the lower portion are threadedly connected.

5. The valve of claim 4, wherein the seat member is secured between the upper portion of the body and the lower portion of the body.

6. The valve of claim 1, wherein the valve is configured for attachment to a top surface of a fluid storage tank.

7. The valve of claim 1, wherein the plunger conduit is isolated from the chamber when the plunger is in the closed position.

8. The valve of claim 1, wherein the apertures are provided in a circumferentially spaced apart arrangement proximate to a periphery of the seat member.

9. The valve of claim 1, wherein the valve is an integrated assembly.

10. The valve of claim 1, wherein each of the body, the seat member, the plunger and the float are unitary components that are assembled to form the valve.

11. The valve of claim 1 further comprising a receiving element coupled to the body, the receiving element configured to provide fluid to the valve.

12. The valve of claim 1, wherein the float further comprises a circumferential channel surrounding the distal end of the plunger.

13. A diesel exhaust fluid (DEF) tank comprising:
a valve positioned at a top surface of the tank, the valve having an inlet configured to receive a supply of DEF, the valve comprising:
a body defining a chamber within the body;
a seat member disposed within the chamber, the seat member including apertures defining a DEF flow path from the inlet into the chamber;
a plunger disposed through the body and in fluid communication with the chamber, the plunger including a tubular wall defining a conduit therethrough; and
a float attached to a distal end of the plunger, wherein the plunger and the float are configured to move relative to the body and the seat member between an open position and a closed position, and wherein the apertures in the seat member are positioned radially outward of the plunger tubular wall.

14. The DEF tank of claim 13, wherein the body is configured for attachment to a receiving element, the receiving element configured to receive the DEF into the tank from a source of DEF supply.

15. The DEF tank of claim 13, wherein an outer surface of the body includes threads for coupling the valve with corresponding threads provided on the tank.

16. The DEF tank of claim 15 further comprising a sealing ring disposed between the outer surface of the body and the tank.

17. The DEF tank of claim 13, wherein the chamber is sized to be larger than the plunger such that the chamber defined within the body surrounds a portion of the plunger disposed within the body.

18. The DEF tank of claim 13, wherein the plunger conduit is isolated from the chamber when the plunger is in the closed position.

19. A valve assembly comprising:
a body configured to receive a supply of fluid, the body defining a chamber within the body and comprising an inlet;
a seat member disposed within the chamber, the seat member including apertures defining a fluid flow path from the inlet into the chamber;
a plunger disposed through the lower portion and in fluid communication with the chamber, the plunger including a tubular wall defining a conduit therethrough; and
a float attached to a distal end of the plunger, wherein the plunger and the float are configured to move relative to the body and the seat member between an open position and a closed position, and wherein the apertures in the seat member are positioned radially outward of the plunger tubular wall.

20. The valve assembly of claim 19, wherein the apertures are provided in a circumferentially spaced apart arrangement proximate to a periphery of the seat member and wherein the plunger conduit is isolated from the chamber when the plunger is in the closed position.
